(19) United States
(12) Patent Application Publication
(10) Pub. No.: US 2008/0250604 A1
(43) Pub. Date: Oct. 16, 2008

(54) Elastic device of a hinge

(76) Inventors: Ken-Ching Chen, Lu-Chu Hsiang (TW); Hsiu-Chiang Liang, Lu-Chu Hsiang (TW); Chun-Chiang Wang, Lu-Chu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,118

(22) Filed: Apr. 16, 2007

(51) Int. Cl. E05D 11/00

(52) U.S. Cl. 16/225

(57) ABSTRACT

An elastic device of a hinge includes a hinge cup, a hinge arm, a connecting pivot, and a leaf spring. The hinge cup has an accommodation. The hinge arm has a cam section which is secured in the accommodation by the connecting pivot. The leaf spring is a U-shaped plate which has a fixed section at one end and a tongue at the other end. The fixed section is flush with the bottom of the accommodation and secured thereat. The tongue extends through a slot of the hinge arm and is against the cam section of the hinge arm.

### BACKGROUND OF THE INVENTION

1. Field of the Invention

The present invention relates to an elastic device of a hinge, in particular to one having a U-shaped leaf spring secured in an accommodation of a hinge cup to provide a restoring force to the hinge.

2. Description of the Prior Art

Hinges have been widely applied to furniture. The basic design includes a hinge cup, a hinge arm and a fixture. The hinge arm is pivotally connected to the hinge cup in a swiveling manner. The hinge cup is usually secured to a cabinet door. A resilient element is located in the hinge cup to provide a restoring force to the hinge arm in order to pull the cabinet door back and close the cabinet.

Most of the conventional resilient elements are made in a spring, such as U.S. Pat. Nos. 5,604,956; 5,617,612; 6,393,663 B1; 6,477,737 B2; 6,845,544 B2; and 6,880,205 B2. Another type of the resilient element is made in a leaf spring, such as U.S. Pat. No. 6,360,401 B1.

The above-mentioned resilient elements are designed to meet different hinges, however, all of these types of hinges have a short service life time.

### SUMMARY OF THE INVENTION

The present invention is to provide an elastic device of a hinge, which solves the compromise problems between a hinge arm and a hinge cup upon the hinge is closed so as to provide a steady restoring force to the hinge.

According to the present invention, there is provided an elastic device of a hinge comprising a hinge cup, a hinge arm, a connecting pivot, and a leaf spring, said hinge cup having an accommodation, said hinge arm having a cam section secured in said accommodation by said connecting pivot, said leaf spring being a U-shaped plate having a fixed section at one end and a tongue at another end, said fixed section being flush with the bottom of said accommodation of said hinge cup, the bottom of said accommodation being provided with fixing pieces to engage with said fixed section and secure said fixed section in place, said hinge arm being disposed with a slot adjacent to said cam section, said tongue of said leaf spring extending through said slot and being against said cam section of said hinge arm; wherein the bottom of said accommodation of said hinge cup is provided with restraining studs, said restraining studs and said fixing pieces engaging with said fixed section, said fixing pieces being bent to secure said fixed section in place; wherein said restraining studs on the bottom of said accommodation correspond to and engage with the edge of said fixed section; wherein said fixed section of said leaf spring is formed with holes for insertion of said restraining studs; wherein the bottom of said accommodation is provided with openings and fixing pieces and said fixed section of said leaf spring is provided with restraining studs to be inserted through said openings, said fixing pieces being bent to secure said fixed section in place; wherein said fixed section of said leaf spring is formed with locating holes and the bottom of said accommodation of said hinge cup is provided with fixing pieces, said fixing pieces extending through said locating holes and being bent to secure said fixed section in place.

It is the primary object of the present invention to provide an elastic device of a hinge, which comprises a U-shaped leaf spring to provide a long service life time.

It is another object of the present invention to provide an elastic device of a hinge, which has an adequate space between the leaf spring and the accommodation of the hinge cup to allow the hinge arm to be inserted therein.

### BRIEF DESCRIPTION OF THE DRAWINGS

FIG. 1 is an exploded view of a first embodiment of the present invention;

FIG. 2 is a perspective view of the first embodiment of the present invention;

FIG. 3 is a side cross-sectional view of the first embodiment of the present invention in a collapsed status;

FIG. 4 is a side cross-sectional view of a second embodiment of the present invention;

FIG. 5 is a side cross-sectional view of a third embodiment of the present invention;

FIG. 6 is a side cross-sectional view of a fourth embodiment of the present invention.

### DETAILED DESCRIPTION OF THE PREFERRED EMBODIMENTS

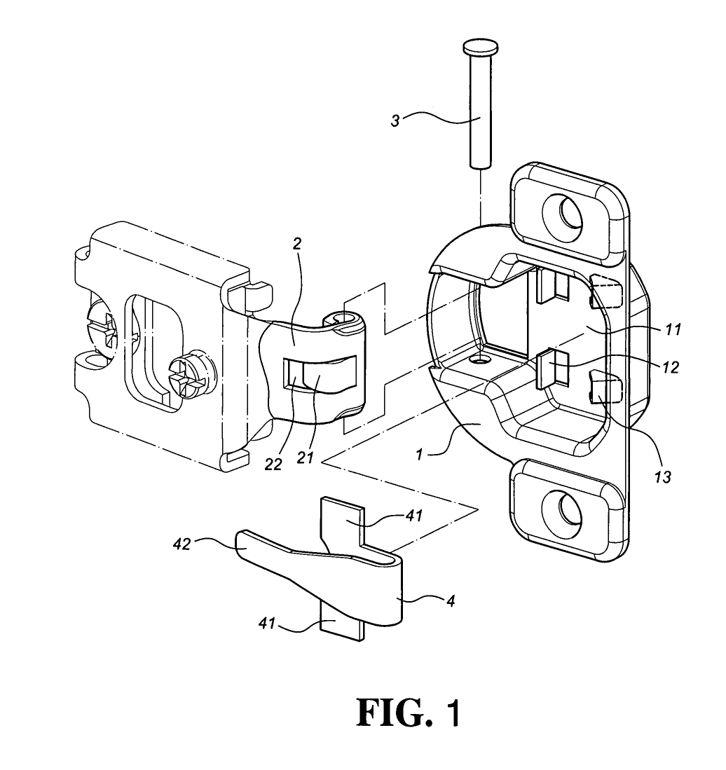

As shown in FIG. 1, a first embodiment of the present invention comprises a hinge cup 1, a hinge arm 2, a connecting pivot 3 and a leaf spring 4. The hinge cup 1 has an accommodation 11. The hinge arm 2 has a cam section 21 which is secured in the accommodation 11 by the connecting pivot 3.

The bottom of the accommodation 11 of the hinge cup 1 is provided with fixing pieces 12 and restraining studs 13.

The hinge arm 2 is disposed with a slot 22 adjacent to the cam section 21.

The leaf spring 4 is a U-shaped plate which has a fixed section 41 at one end and a tongue 42 at the opposite end thereof.

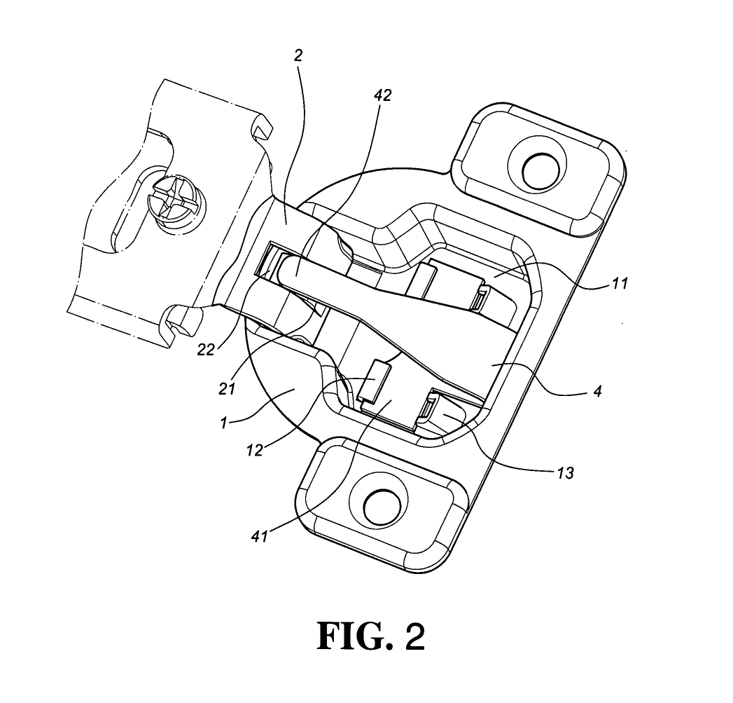

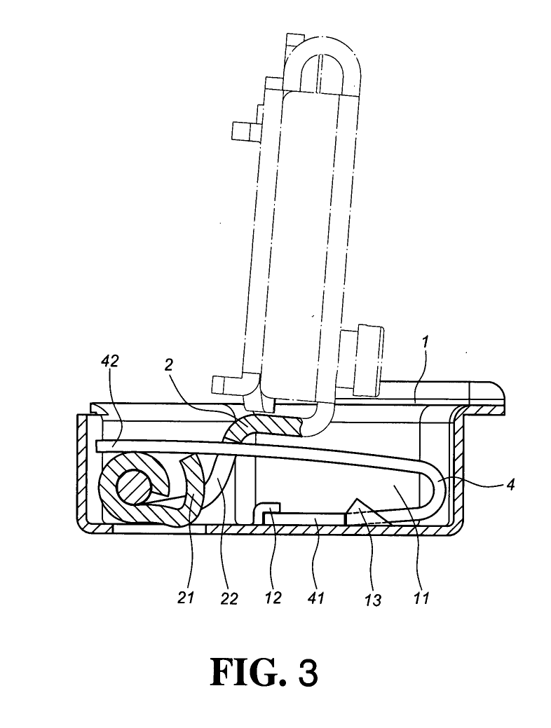

To operate the present invention, as shown in FIGS. 2 and 3, the leaf spring 4 is placed into the accommodation 11 of the hinge cap 1, and the fixed section 41 of the leaf spring 4 is flush with the bottom of the accommodation 11 of the hinge cup 1. The tongue 42 extends through the slot 22 of the hinge arm 2 and is against the cam section 21. The restraining studs 13 provided on the bottom of the accommodation 11 engage with one side of the fixed section 41 of the leaf spring 4, while the fixing pieces 12 are bent to engage with the other side of the fixed section 41.

When the hinge is collapsed, as shown in FIG. 3, the hinge arm 2 will be moved towards the accommodation 11 of the hinge cap 1 and be located above the leaf spring 4.

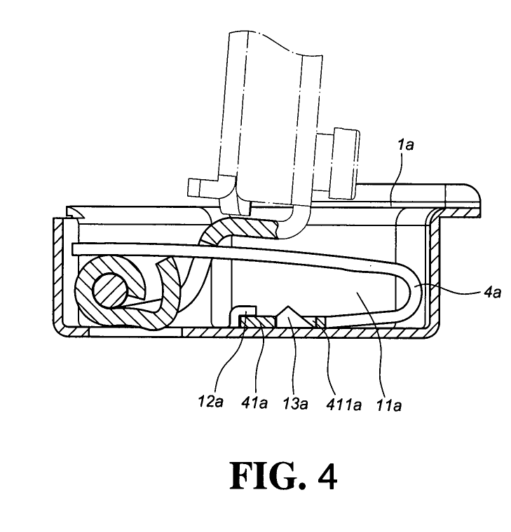

FIG. 4 shows a second embodiment of a hinge cup 1a and a leaf spring 4a of the present invention. A fixed section 41a of the leaf spring 4a is formed with holes 411a for insertion of restraining studs 13a provided on the bottom of an accommodation 11a of the hinge cup 1a, while fixing pieces 12a provided on the bottom of the accommodation 11a are bent to engage with the edge of the fixed section 41a.

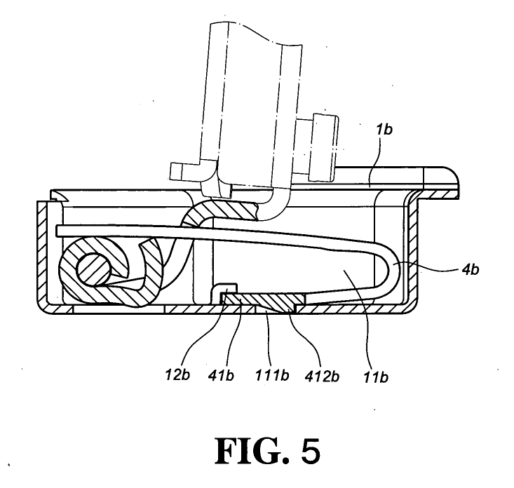

FIG. 5 shows a third embodiment of a hinge cup 1b and a leaf spring 4b of the present invention. The hinge cup 1b has an accommodation 11b. The bottom of the accommodation 11b is formed with openings 111b. A fixed section 41b of the leaf spring 4b is provided with restraining studs 412b to be inserted through the openings 111b, while fixing pieces 12b provided on the bottom of the accommodation 11b are bent to engage with the edge of the fixed section 41b.

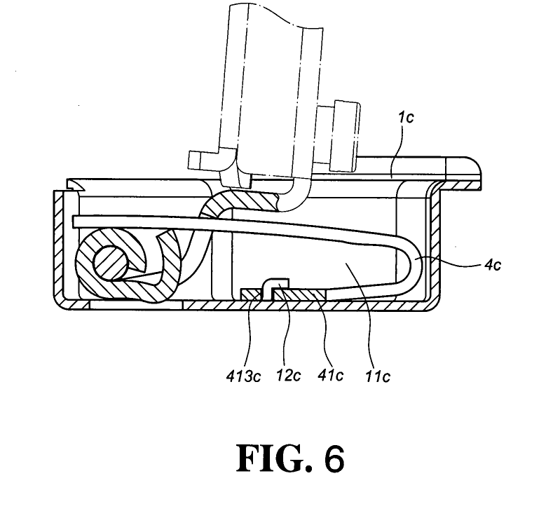

FIG. 6 shows a fourth embodiment of a hinge cup 1c and a leaf spring 4c of the present invention. A fixed section 41c of the leaf spring 4c is formed with locating holes 413c. The hinge cap 1c has an accommodation 11c. The bottom of the accommodation 11c is provided with fixing pieces 12c. The fixing pieces 12c extend through the locating holes 413c of the leaf spring 4c and are bent to secure the leaf spring 4c in place.

1. A hinge system comprising a hinge cup, a hinge arm, a connecting pivot, and a leaf spring, wherein said hinge cup has an accommodation and said hinge arm has a cam section secured in said accommodation by said connecting pivot, and characterized by:
said leaf spring being a U-shaped plate having a fixed section at one end and a tongue at another end, said fixed section being flush with the bottom of said accommodation of said hinge cup, the bottom of said accommodation being provided with fixing pieces to engage with said fixed section and secure said fixed section in place, said hinge arm being formed with a slot passing therethrough adjacent to said cam section, said tongue of said leaf spring extending through said slot and abutting said cam section of said hinge arm.

2. The hinge system, as recited in claim 1, wherein the bottom of said accommodation of said hinge cup is provided with restraining studs, said restraining studs and said fixing pieces engaging with said fixed section, said fixing pieces being bent to secure said fixed section in place.

3. The hinge system, as recited in claim 2, wherein said restraining studs on the bottom of said accommodation correspond to and engage with the edge of said fixed section.

4. The hinge system as recited in claim 2, wherein said fixed section of said leaf spring is formed with holes for insertion of said restraining studs.

5. The hinge system, as recited in claim 1, wherein the bottom of said accommodation is provided with openings and fixing pieces and said fixed section of said leaf spring is provided with restraining studs to be inserted through said openings, said fixing pieces being bent to secure said fixed section in place.

6. The hinge system, as recited in claim 1, wherein said fixed section of said leaf spring is formed with locating holes and the bottom of said accommodation of said hinge cup is provided with fixing pieces, said fixing pieces extending through said locating holes and being bent to secure said fixed section in place.
